(19) United States
(12) Patent Application Publication
(10) Pub. No.: US 2011/0219461 A1
(43) Pub. Date: Sep. 8, 2011

(54) NETWORK BASED DIGITAL RIGHTS MANAGEMENT SYSTEM

(75) Inventors: Anselm P. Baird-Smith, San Jose, CA (US); Vu Nguyen, Hillsborough, CA (US); Raymond Walsh, San Jose, CA (US); William A. Alvarado, Palo Alto, CA (US); Zelidrag Hornung, Burlingame, CA (US)

(73) Assignee: la la media, inc., Cupertino, CA (US)

(21) Appl. No.: 13/045,498

(22) Filed: Mar. 10, 2011

Related U.S. Application Data
(62) Division of application No. 12/126,583, filed on May 23, 2008.
(60) Provisional application No. 61/040,790, filed on Mar. 31, 2008.
(60) Provisional application No. 60/939,919, filed on May 24, 2007.

(51) Int. Cl. G06F 21/24

(52) U.S. Cl. 726/30

(57) ABSTRACT

A network-based DRM system manages digital media assets stored in the network. The system provides consumers with access to the digital media from any device connected to an electronic network such as the internet, while enforcing the intended uses by the copyright owners.

### CROSS-REFERENCE TO RELATED APPLICATIONS

This application claims the benefit of U.S. Provisional Patent Application Nos. 60/939,919 filed May 24, 2007 and 61/040,790 filed Mar. 31, 2008.

### BACKGROUND OF THE INVENTION

The present invention relates to a network-based system for distributing and consuming digital media while preserving the rights of the original copyright owners including artists, publishers, labels, and distributors.

Digital music emerged and introduced users to a new way to acquire and consume music. The digital medium gives consumers instant access to music via electronic networks, such as the internet. The emergence of widely adopted standards such as MP3 allows consumers to acquire music anywhere on the internet and play them on their personal computers (PCs) and portable devices.

However, digital music has also created a serious intellectual property protection problem. Beginning with Napster®, the music industry has been unable to control the distribution of music via person-to-person (P2P) sites, download sites, and the like. This illegal sharing of music has resulted in significant loss of sales.

Many Digital Rights Management (DRM) technologies have emerged including Microsoft's Windows Media® DRM and Apple's FairPlay®. These technologies have suffered from a lack of interoperability due to competitive/licensing issues as well as expensive implementation requirements. A successful DRM protection scheme requires implementation by services, device manufacturers and software player developers. Furthermore, once implemented, even the most secure DRM implementations can be broken—once again leaving files unprotected.

### BRIEF SUMMARY OF THE INVENTION

Preferred embodiments of the present invention provide a network-based DRM system that manages digital media assets stored in the network. The system provides consumers with access to the digital media from any internet-connected device while enforcing the intended uses by the copyright owners.

For consumers, the present invention provides the benefits of portability/convenience and instant gratification enabled by a network-based system. The system also provides a more future-proof service capable of delivering new media types/formats from the web as technology changes.

For the content owners, a network-based approach protects against rampant piracy. By delivering the product directly from the network, only authorized users and devices can access the media. Access by users and devices is controlled on the web and can be constantly adapted to changing technologies and market pressures.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. However, the invention is not limited to the precise arrangements and instrumentalities shown.

In the drawings:

FIG. 1 is a schematic block diagram of a network-based DRM system in accordance with one preferred embodiment of the present invention.

FIG. 2 is a table that illustrates how the DRM process can implement access rules in accordance with preferred embodiments of the present invention.

FIGS. 3-11 are screen shot displays of user interface screens for use in accordance with preferred embodiments of the present invention.

FIG. 12 is a schematic block diagram of a network-based Synchronization Platform System in accordance with one preferred embodiment of the present invention.

FIGS. 13-18 are screen shot displays of user interface screens associated with a gifting process in accordance with preferred embodiments of the present invention.

FIGS. 19-24 are database tables for one preferred embodiment of the network-based DRM system.

### DETAILED DESCRIPTION OF THE INVENTION

Certain terminology is used herein for convenience only and is not to be taken as a limitation on the present invention.

The present invention is described in the context of a preferred embodiment of a web-based software application commercialized on the World Wide Web at lala.com, which is a music trading and purchasing site. This site is described, in part, in U.S. Application Publication No. 2007/0244768 (Nguyen et al.) entitled “Article Trading Process,” which is incorporated by reference herein. Lala.com is a service of la la media, inc., Palo Alto, Calif. However, the scope of the present invention is not limited to this particular implementation of the invention and may be implemented separate from this platform.

The present invention is described in the context of a plurality of distributed computers, all of which are linked together by an electronic network, such as the Internet. The computers may be any type of computing device that allows a user to interact with a web site via a web browser. For example, the computers may be personal computers (PC) that run a Microsoft Windows® operating system. The computers may also be handheld, wireless devices.

### I. DEFINITIONS

The following definitions are provided to promote understanding of the present invention. digital media content file: This file holds the actual content of the digital media. If the digital media is audio or audio/visual content, then the digital media content file can be any conventional type of audio file format (e.g., mp3, aav, way) or video file format (e.g., avi, mpg, yob, asf, wmv, mp4, ogm, 3gp, divX, or other formats used on DVDs). In the music environment, an “individual digital media content file” may be particular track (song), playlist, or album, and does not include an entire catalog of music from disparate artists, such as all music owned or licensed by a particular record label. The digital media content file includes the full contents of the work, as opposed to excerpts or snippets. For example, if the work is a song, the file includes the full song, not 30 second samples.

media content device: This device holds and/or plays digital media content files. In one preferred embodiment, the media content device is a portable digital music player, such as an MP3 player (either a separate device or part of a cell phone or other auxiliary portable electronic device), an iPod®. In another embodiment, the media content device is a portable storage device only, such as a flash memory. In another preferred embodiment, the media content device is a computer, such as a PC that has media playing software installed therein. In the embodiments wherein the user is only permitted to stream media, the media content device does not permanently store the digital media content files, but may temporarily store the files in random access memory or the like to facilitate seamless playing.

own: ownership as used herein is defined by the rights conveyed or licensed by the entity that the user acquires rights of use. In most instances, the user acquires access rights from a copyright owner, and thus ownership means ownership of license rights defined by the copyright owner. In instances where the user creates a work, ownership provides more extensive rights provided under the copyright laws for such creators.

album: one or more audio recordings issued together, originally released on 12-inch phonograph records (usually with record covers) and later on cassette audio tape and now usually on compact disc. Albums and compact discs (CDs) or “discs” are used interchangeably throughout the disclosure.

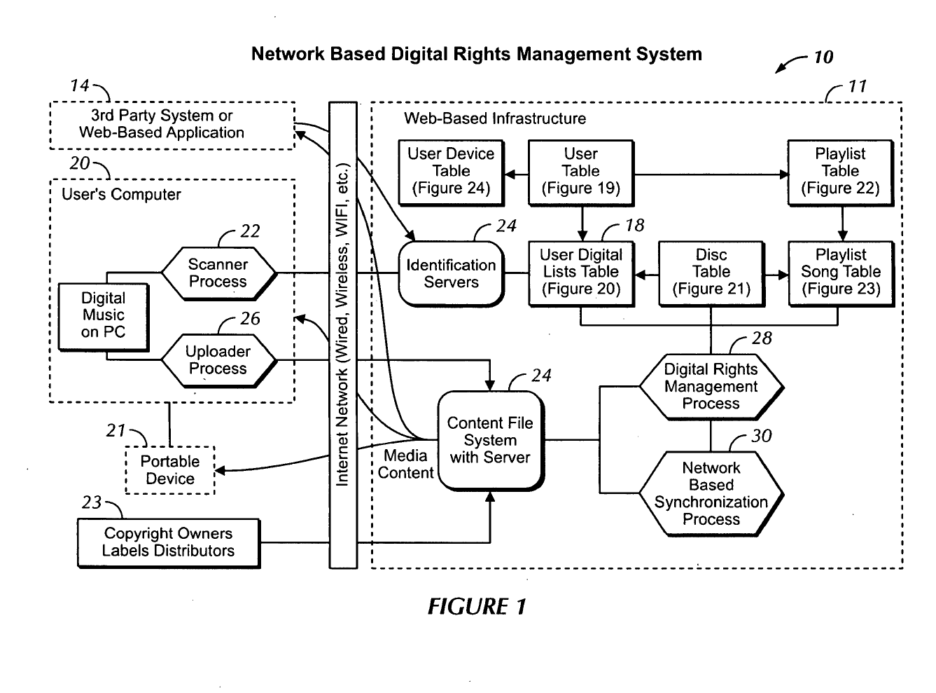

host computer system: a computer or processor that administers the network-based DRM System of FIG. 1. The host computer system may be a single computer or a network of computers, such as a server or network of servers. The host computer system includes the “Web-based Infrastructure” and the “3rd party system or web-based application” shown in FIG. 1. Preferably, the “Web-based Infrastructure” provides the primary administrative functions of the service, and the “Web-based Infrastructure” with the optional assistance of the “3^{rd} system or web-based application” together provides purchasing and delivery components of the service, as described in more detail below.

unlimited streaming: The scope of “unlimited” includes having no restrictions on the number of times that a digital media content file can be played for either a fixed period of time or forever, and also includes a finite number of times over a fixed time period that is great enough to be perceived by the user as being effectively unlimited based on even very heavy usage patterns, while providing for protection against user abuse.

### II. OVERVIEW OF PRESENT INVENTION

In one preferred embodiment, digital media content files are delivered from a host computer system via an electronic network to media content devices associated with a plurality of authorized users. This process operates as follows:

1. A plurality of different levels of access rights are provided to individual digital media content files. Each of the different levels of access rights has an associated payment amount. More specifically, a first level of access rights has a first payment amount which provides unlimited streaming rights to an individual digital media content file from the host computer system to a user's media content device who has paid the first payment amount. One or more other levels of access rights have respective payment amounts greater than the first payment amount which provides less restrictive access rights to the digital media content file than the first level of access rights.
2. The host computer system maintains records of a plurality of authorized users and a level of access rights for any digital media content file that a user has made a payment for.
3. Individual digital media content files are delivered from the host computer system via the electronic network to the media content devices associated with a plurality of authorized users in accordance with the user's level of access rights maintained in the host computer system.

A level of access rights upgrade payment can be made so as to increase the access level from the first level of access rights to the one or more other levels of access rights. For example, one of the other levels of access rights may provide for downloading of the digital media content file from the host computer system to a user's media content device.

The host computer system may include a plurality of sources of digital media content files, including existing third-party sources of such digital media content files.

“Web Songs” (discussed below) provides one example of such unlimited streaming rights.

In another preferred embodiment for delivering digital media content files, the host computer system has a purchasing component and a delivery component and the selected digital media content files are maintained at the host computer system. The purchasing component may include a plurality of sources for purchasing digital media content files. Likewise, the delivery component may include a plurality of sources for delivering digital media content files. This process operates as follows:

1. A digital media file list is maintained for each user at the host computer system that includes digital media content files that the user is permitted to receive.
2. The digital media file list is populated by scanning storage files of the user's computer to identify any digital media content files stored therein, uploading a list of any identified digital media content files to the host computer system, and adding to the list any digital media content files that the user purchases from the purchasing component of the host computer system.
3. A digital catalog user interface display screen is provided that includes the entries in the digital media file list and allows for user selection of entries.
4. The digital media content files are delivered from the delivery component of the host computer system via the electronic network to the media content devices associated with a plurality of authorized users in accordance with the user's selected entries.

In another preferred embodiment of the present invention, the host computer system is populated with digital media content files for subsequent delivery of the digital media content files. This process operates as follows:

1. Storage files of the user's computer are scanned to identify any digital media content files stored therein.
2. A list of any identified digital media content files is uploaded to the host computer system.
3. The list of the identified digital media content files is compared with the digital media content files currently maintained at the host computer system and any digital media content files stored in the user's computer that are not currently maintained at the digital media content file are identified.
4. The host computer system requests from the user's computer any identified digital media content files stored in the user's computer that are not currently maintained at the host computer system.
5. Any such identified digital media content files are automatically uploaded from the user's computer to the host computer system. In this manner the host computer system will be able to subsequently deliver digital media content files via the electronic network to media content devices associated with the user without needing to access any digital media content files stored on the user's computer.

The digital media content files in the host computer system are preferably stored in a predefined number of supported formats. Thus, the format of any identified digital media content files stored in the user's computer that are not currently maintained at the digital media content file is checked and any such digital media content files that are not in one of the predefined number of supported formats may be transcoded into one of the predefined supported formats prior to the automatic uploading.

Another embodiment for delivering digital media content files to media content devices allows for different levels of access rights depending upon the type of media content device that the digital media content file is delivered to. This process operates as follows:

1. A plurality of different levels of access rights is provided to individual digital media content files. Each of the different levels of access rights are dependent upon the type of media content device that the individual digital media content file is delivered to.
2. Records are maintained in the host computer system of the different level of access rights for each of the different types of media content devices.
3. Individual digital media content files are delivered from the host computer system via the electronic network to the media content devices in accordance with the level of access rights maintained in the host computer system.

In other embodiments, gifts can be made of access rights to individual digital media content files. To facilitate the gifting process, the host computer system compares the gift request to the user's digital media file list to determine if the level of access rights that the gift giver has requested is already permitted by the user for the individual digital media content file. The gift request is only accepted if the level of access rights is not already permitted by the user. If the user already has the access rights requested by the gift giver, the host computer system preferably suggests either a different, less restrictive level of access rights if one exists, or suggests a different digital media content file to give as a gift. The suggestion may be generated from an analysis of metadata associated with the contents of the user's current digital media file list.

The gift may be for a digital media content file that the user does not have any access to, such as a “Web Song” or the gift may be an upgrade in the level of access rights to a less restrictive level, such as upgrading the user from unlimited streaming only (“Web Song”) to downloading access rights.

Upon completion of processing the gift request, the individual digital media content file is immediately added to the digital media file list so that the user has immediate access rights to the individual digital media content file without the user needing to take any action to facilitate the access rights associated with the gift. Thus, the user does not need to redeem credits, respond to an email message, or enter any codes, account numbers or passwords to receive the gift. Preferably, the host computer system allows the user to exchange the gift for an account credit for the monetary value of the gifted access rights to apply towards access rights to a different individual digital media content file, or for an immediate exchange for access rights to a different individual digital media content file that has a monetary value similar to the monetary value of the gifted access rights.

### III. DETAILED DISCLOSURE

One implementation of the present invention is described below.

### 1. Aggregating and Storing Digital Media for Management

FIG. 1 shows a network-based DRM System 10 that includes Web-based infrastructure 11, 3^{rd} Party System or Web-based application 14, User's Computer 20, and any portable device 21 associated therewith. A Content File System (CFS) 12 directly stores the actual digital media under management, and/or (in some instances as discussed below) maintains records of remote locations where such digital media is stored. The CFS 12 can be populated in several ways:

a. The copyright owner 23 (e.g., label, distributor) chooses to make the digital media available for use.

b. Users may choose to upload content already owned (see Uploader process below).

c. Third parties can make their digital media available so that it is managed by the web-based infrastructure 11 (see 3^{rd} party system or web-based application 14). The “host computer system” referred to herein includes the combination of the web-based infrastructure 11 and any 3^{rd} party system or web-based application 14 that interacts with the web-based infrastructure 11 to extend its capabilities, for both purchasing of digital media and delivering of digital media from and to users.

In a music example, the digital tracks are stored in the CFS 12 within the web-based infrastructure 11. The CFS 12 manages the serving of digital tracks for approved use by other components of the system (e.g., streaming, downloading). By storing the media, the web-based infrastructure 11 can provide an end-to-end solution for accessing the media.

A server in the CMS 12 generates a file path that identifies its location, the source that populated the content, and a common key to the catalog managed by the system. For example, the following structure may be used:

/base/user/short/long/content

where:

base=path base shared by all

user=hash of user identifier

short=short hash of content

long=long hash of content

content=proprietary content identifier matched to the discid table.

### 2. Granting Access to the Digital Media

Access to the digital media is controlled by the Digital Rights Management (DRM) process. The DRM process 28 is invoked any time that a user interacts with the managed digital media. The purpose of the DRM process is to assign permissible uses for specific digital media (e.g., a song) for a given user.

Permissible Uses granted by the DRM process may include:

a. Listen/Play the digital media on a device or computer.

b. Download the digital media to a device or computer.

c. Restore a Backup of the digital media using the system.

d. Share/Transfer rights of the digital media using the system.

The DRM process can utilize a number of inputs to determine the permissible uses for digital media including the following inputs:
a. User's account status (e.g., account in good standing, premium account)
b. User ownership status of the digital media (e.g., purchased, previously scanned on the PC, ownership revoked)
c. Type of access device (e.g., PC, portable device class and model, mobile phone)
d. Copyright Owner of digital media (e.g., Warner® Music, specific artist)
e. Source of digital media user uploaded, label licensed

The outcome of the DRM process is to provide access to the ‘most valuable’ asset permissible for the user and device requesting the access. The DRM process is capable of computing the permissible uses in real-time, providing real-time control over the assets. For example, in music, the DRM Process will first check for access to digital tracks provided by the copyright owner. If the user does not meet the necessary criteria, it will check for user uploaded content. If this is not available, the system will check for availability and permission to access 30 seconds samples. This process will continue until an acceptable asset is found or it is deemed that no asset can be provided.

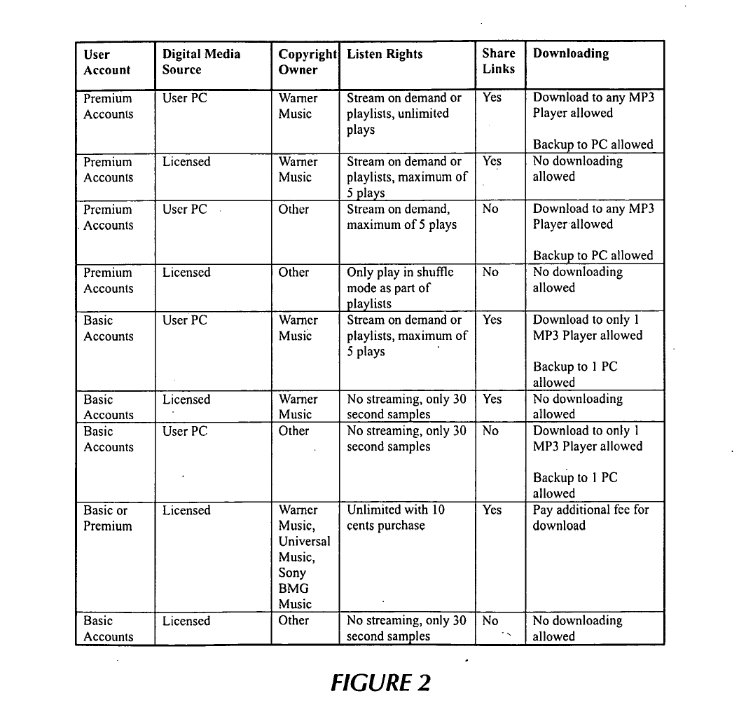

If an asset is found, the DRM process will provide an authorized link to the actual digital media assets stored in the system (or 3^{rd} party system). These links may have different expiration/access rules based on the content characteristics. FIG. 2 is a table that illustrates examples of how the DRM process can implement access rules in one preferred embodiment. The scope of the invention is not limited to this one set of access rules.

3. Importing and Maintaining Information about Digital Media Owned by a User

The system 10 provides an infrastructure for capturing and maintaining a list of the digital media owned by a user. This information can be used as an input to determine a user's permissible rights to access digital media managed by the system 10. This information is stored in the User Digital List table (FIG. 20-Table B). This is the table that stores the “digital media file list” referred to herein.

### 3.1. User Digital List

To obtain a User Digital List which is maintained in the Digital Lists Table 18 of FIG. 1, a user must first register for an account with the system 10. The user may be offered multiple choices for level of service which may affect their individual rights to specific digital media. For example, a premium account may provide unlimited streaming rights to music in exchange for a monthly subscription fee.

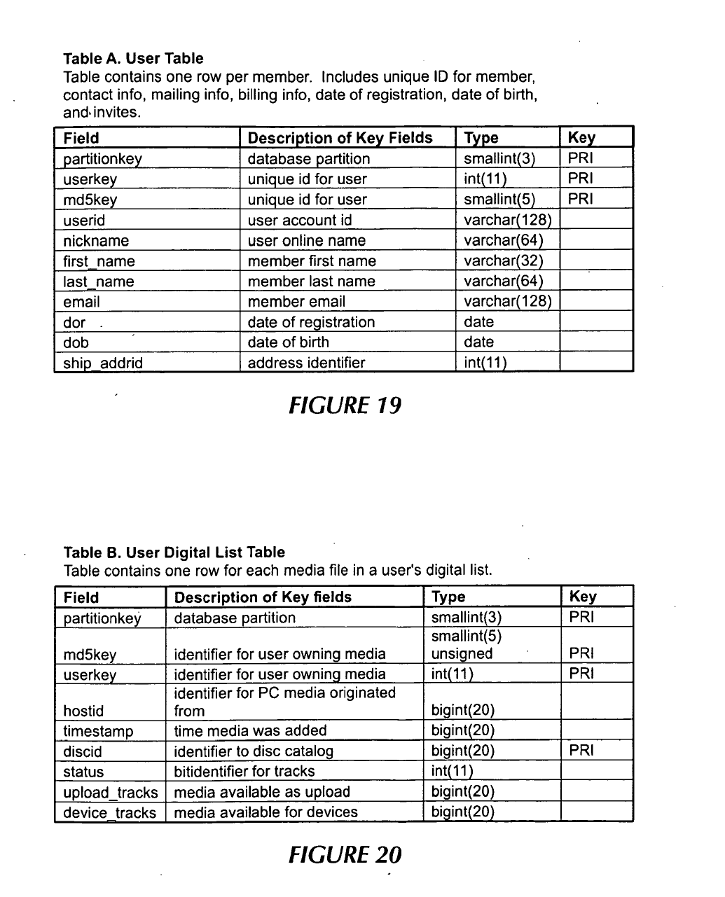

The user account is stored in the User Table (FIG. 19-Table A).

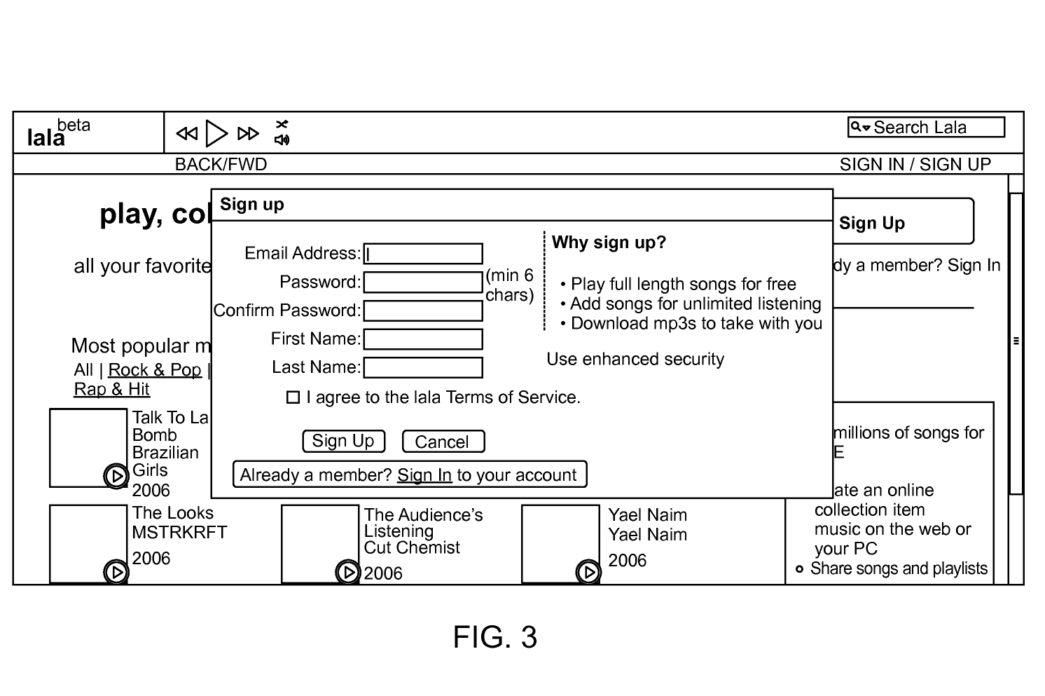

FIG. 3 shows an example of a user interface for account registration.

### 3.2 Submissions to a User Digital List

Once created, a User Digital List can be populated via submissions from a number of sources, such as from a user's computer, web-based catalog, or third-party sites using APIs.

A. FROM A USER'S COMPUTER 20

The list may be populated by indexing the media already existing in a user's computer using a Scanner Process 22. In one preferred embodiment, the scanner process 22 runs on a user's local machine (computer 20). Its purpose is to index the media resident on a computer 20. The scanner process 22 can be started explicitly or implicitly by the user. In one preferred embodiment, the scanner process 22 operates as follows:

a. Scanner counts all of the known media files by file extension.

b. Scanner compares this count to the last known-good scan and quits if the count has not changed.

c. For every file counted, the scanner performs the following steps:
i. Extracts Artist name, Album name, Song name, and a digital fingerprint of the media.
ii. Submits the Artist/Album/Song/Fingerprint info to Identification Server 24 to match the scanned media against the web-based service catalog. One suitable software application for performing the identification is Gracenote® MusicID®, available from Gracenote, Inc., Emeryville, Calif.
iii. Records the results on the local machine (computer 20).
iv. On a match, the proprietary unique identifier is submitted to the web-based infrastructure 11 to be stored in the User Digital List Table (FIG. 20-Table B).

d. When the scanning process is complete, the scanner starts an Uploader Process 26 for media not matched against the web-based service catalog.

The Uploader Process 26:

The Uploader runs on the user's local machine (computer 20). The purpose of the uploader process 26 is to upload digital media to the web-based infrastructure 11. The uploader process 26 can be started explicitly or implicitly by the user. The Uploader performs the following steps:

a. Downloads an upload list from the web-based infrastructure 11, presumably files not already available from content owners.

b. For each digital media file on the list, the Uploader finds the matching source file and transcodes the media into a format supported by the system components, if necessary.

c. The uploader then uploads the correctly formatted digital media to the web-based infrastructure 11 for storage in CFS 12.

In an alternative embodiment for handling digital media in non-compatible formats, the digital media file is uploaded to the web-based infrastructure 11 in its non-compatible format and the transcoding occurs at the web-based infrastructure 11, instead of the user's computer.

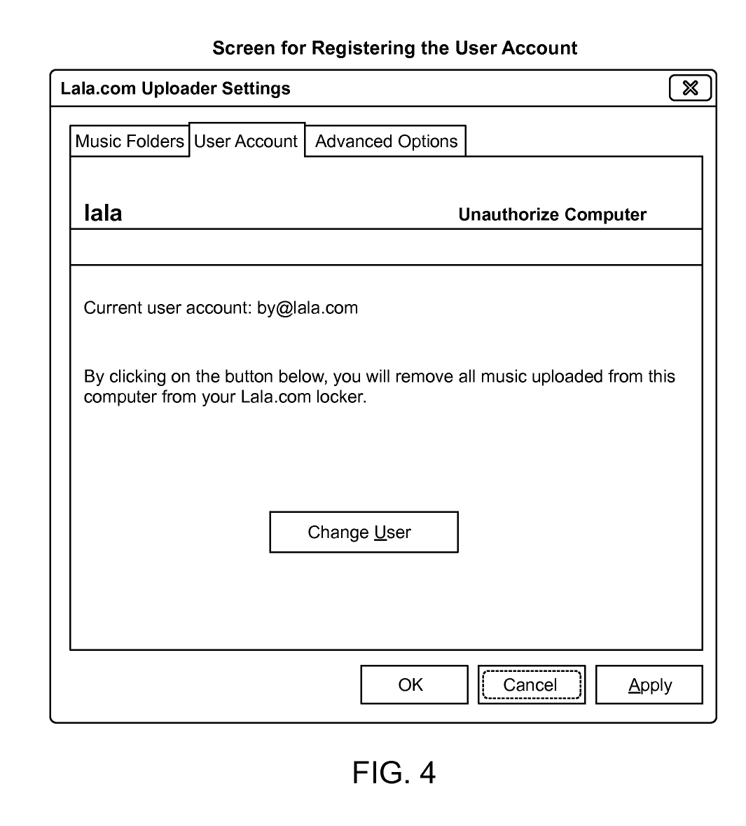

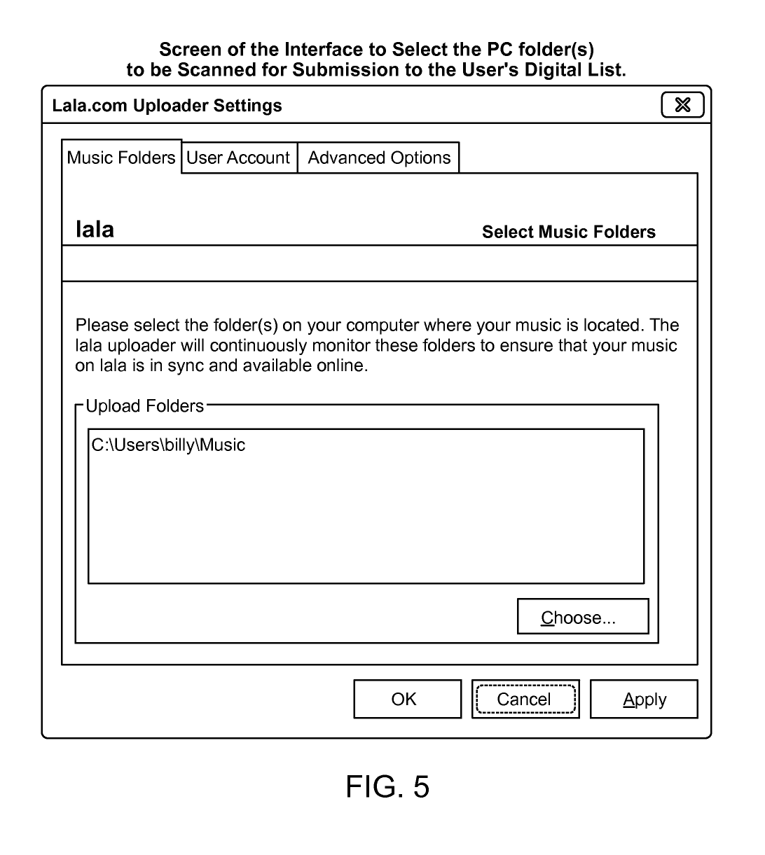

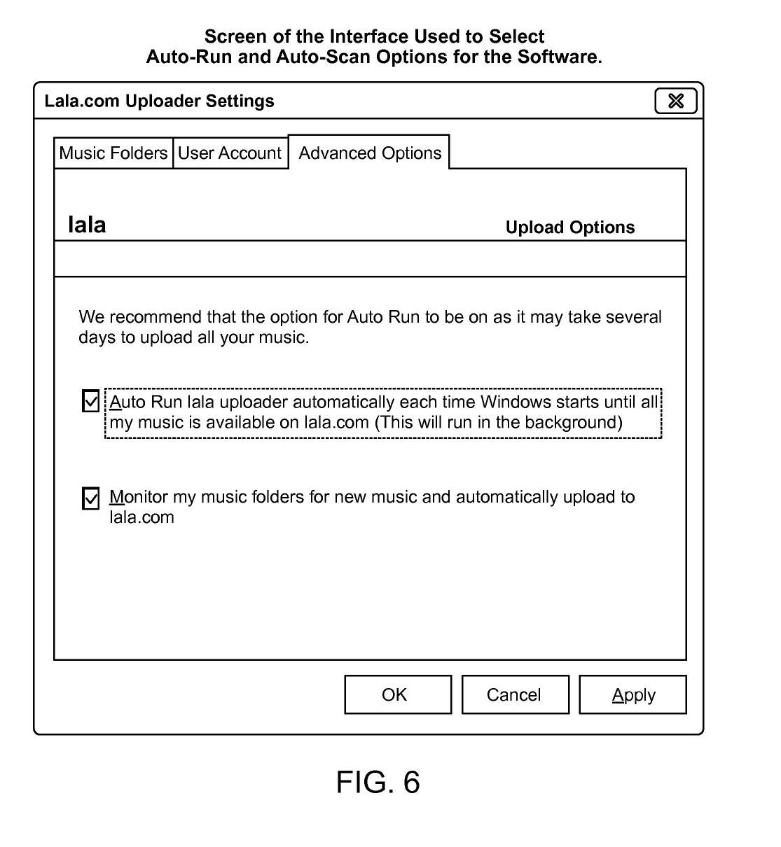

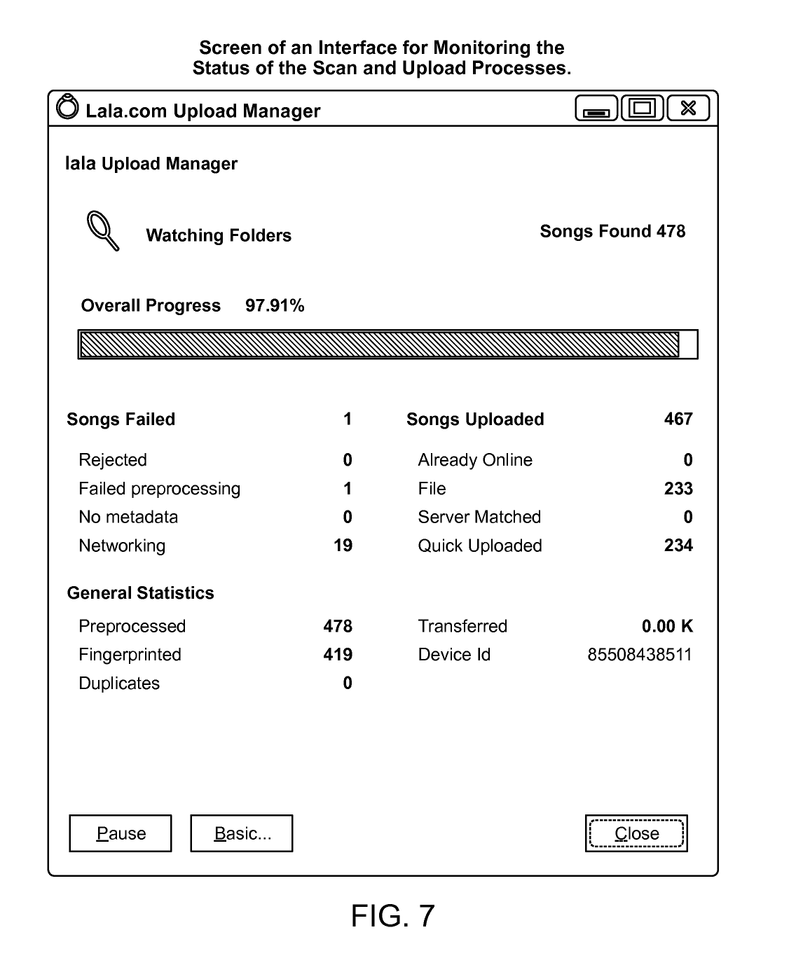

FIGS. 4-7 are sample screens of the software available to users for installation on their computers to manage the Scanning and Uploading process.
FIG. 4 is a screen for registering the user account.
FIG. 5 is a screen to select the PC folder(s) to be scanned for submission to the User's Digital List.
FIG. 6 is a screen of the interface used to select auto-run and auto-scan options for the software.
FIG. 7 is a screen of an interface for monitoring the status of the scan and upload processes.

B. FROM A WEB-BASED CATALOG

The User Digital List may also be populated by adding digital media by selecting from content offered within the system 10. Users could browse for content and add (or purchase) media.

The User Digital List may also be populated directly by end users via manual input. For example, users could register unique identifiers of products owned and/or purchased to prove ownership and add to their digital list.

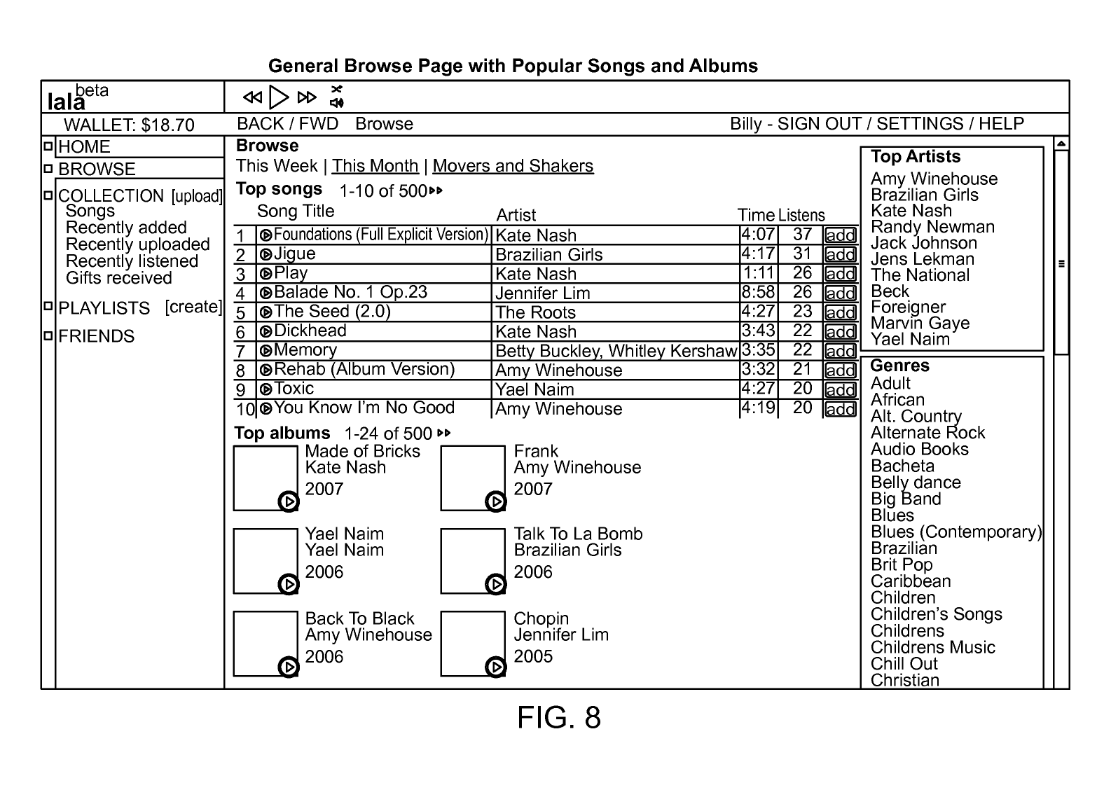

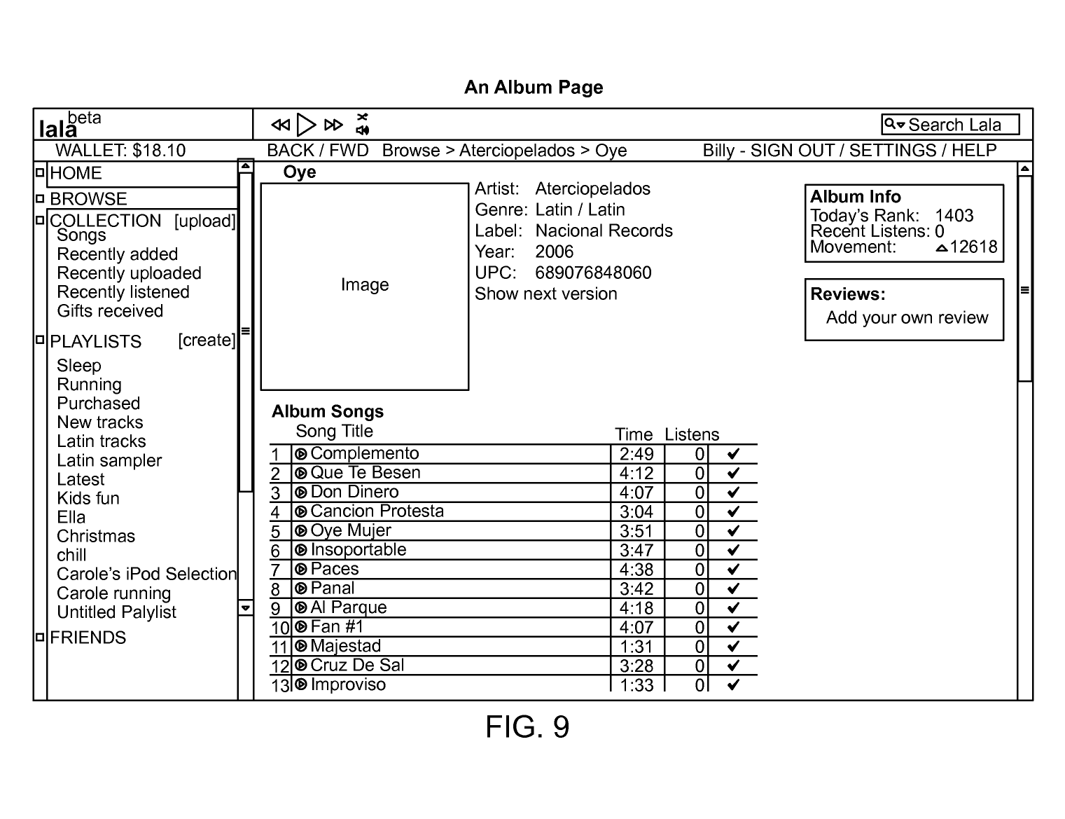

FIGS. 8 and 9 show sample screens displayed via a browser that lists Digital Media in a web-based which users can select to add to their User Digital List (click on add). FIG. 8 shows a General Browse page with popular songs and albums and FIG. 9 shows an album page.

C. FROM THIRD-PARTY SITES USING APIs

The User Digital List may also be populated by third-party websites via a web service any time that a user makes a purchase of media on their site (3^{rd} party system or web-based application 14). For example, a purchase of a CD or a digital album from any online retailer (e.g., Amazon) could also populate the User Digital List.

### 3.3 Processing Submissions to a User's Digital List

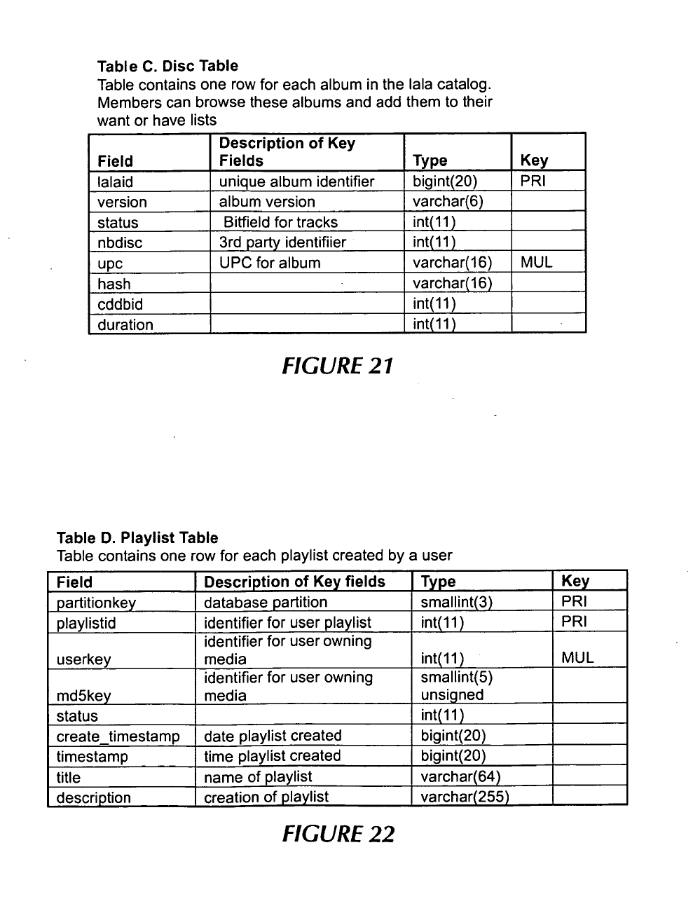

Submissions of digital media to the User Digital List are received by Identification Service associated with the Identification Server 24. The Identification Service can utilize unique media identifiers (e.g., UPC, Global Release Identifier (GRid)) and/or metadata (e.g., artist, album, song name, digital fingerprints) to match the submissions against the catalog of digital media managed by the web-based infrastructure 11. The catalog is stored in the Disc Info Table (FIG. 21-Table C.)

As an example, the Identification service can use Artist/Album/Song/Fingerprint information to identify a song as follows:

i. Service looks for an exact match using all pieces of information in Disc Info Table. If one match is found, a match is recorded.

ii. If more than one exact match is found, greater weight is given to more popular albums.

iii. If an exact match is not found, additional lookups are made until a match is found or all additional lookup pairs are exhausted. Additional lookups include artist+song name, artist+album name, album+song name.

iv. Possible matches are converted to a fuzzy-string (vowels, accents, spaces removed) and compared to the fuzzy version of the input data.

v. For every album identified, a 64-bit bitfield is initialized in the User Digital List Table to record the individual song match. The bit in the bitfield whose position matches the song's number (minus one) is flipped to the “on” state to indicate that this song has been matched.

Once songs have been imported and matched, they can be displayed and accessed using the digital catalog managed by the web-based infrastructure 11.

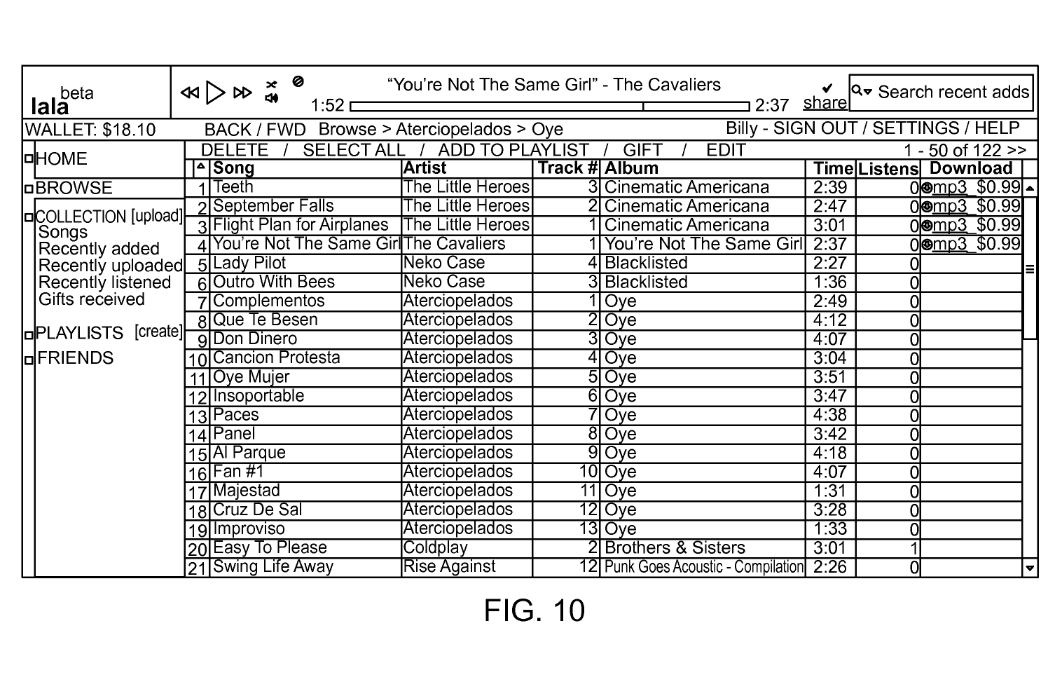

FIG. 10 shows an example of a user interface for playing via the web and downloading to a mobile device or PC.

The system 10 also allows for the ‘revoking’ of ownership of digital media. For example, if a user is known to have illegally shared a file, the copyright owner may choose to revoke their ownership of the digital media in the system, limiting the rights of such user to the media. By providing this option, the system can discourage users from illegally using and/or sharing digital media.

### 4. Web Song Offering

The system 10 can be utilized to offer a number of innovative product and pricing offerings for consumption of digital media. In one preferred embodiment, the system 10 can be used to offer a product referred to herein as “Web Songs” for music consumers to collect and purchase new music in an affordable and convenient manner.

Web Songs grant a user the right to access a particular track, playlists, or album in an online collection on a permanent basis. Web songs provide users with a number of features available online including (i) unlimited streaming rights, (ii) ability to add to playlists, and (iii.) ability to share or gift to other users. To grant access, the system 10 places a token or receipt in the user's digital list which corresponds to the relevant digital media. At all times, the system 10 can revoke this access, enabling offering with different degrees of permanence based on duration (e.g., lifetime or 1 year) or use (e.g., 1000 plays).

Web Songs have at least the following characteristics:

a. They provide the buyer with permanent (or long duration) ownership of digital media for online use controlled by the system 10, all without requiring digital downloads or physical products.

b. They can be purchased at a fraction of the cost (e.g. one-time, 10 cent fee) of traditional offerings such as MP3s and CDs. Web Songs can be purchased at a fraction of the cost because the system 10 functionality results in a lower royalty structure to copyright owners by enabling:

a. A micro-transaction model which results in a larger addressable market and higher transaction volume than traditional products. Key to this model is the online ownership which makes the offering suitable to a number of consumer segments not currently purchasing or subscribing to online music. Because of its reach and volume, the web song also serves as an entry product to then up-sell consumers to traditional and new products.

b. A broad distribution strategy enabled by a web-based offering (no desktop software) where consumers can purchase Web Songs anywhere, any time since the product is delivered to their collection online. Consumers can purchase from any web page or any device which is connected to the Internet.

c. An offering with minimal piracy. The web restricted nature of the offering means that the digital assets are at all times controlled by the system 10 (versus digital files downloaded to users) and thus result in minimal piracy. The convenience and pricing approach also contribute to reduce piracy.

d. They can be upgraded to more traditional products to provide additional functionality. For example, if a consumer buys a Web Song and later decides to they want the song for use with their portable device; the consumer can pay an extra amount to download a digital file of the song (e.g. MP3).

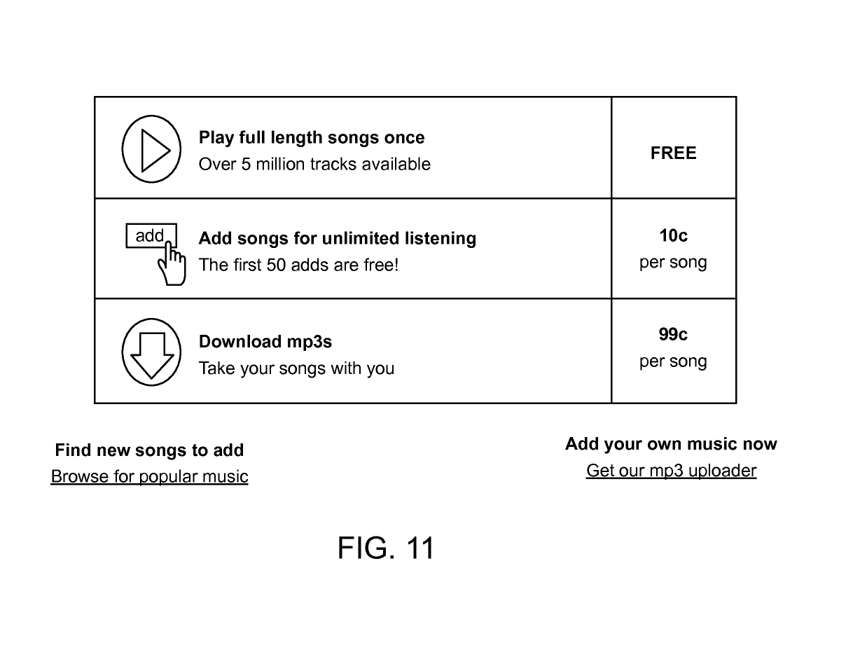

FIG. 11 shows a sample display screen used to communicate to consumers the availability of Web Songs and the progression to additional products on the service.

### 5. Network-based Device Synchronization Process 30

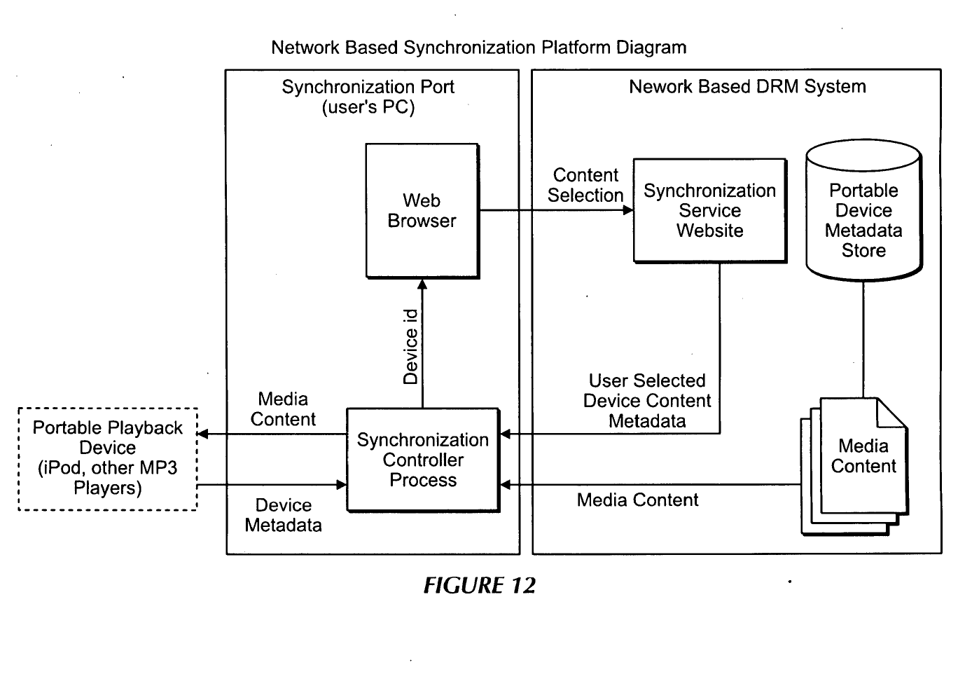

FIG. 12 shows a schematic block diagram of a Network-based Synchronization Platform. This platform implements a process that interacts with the web-based infrastructure 11 to manage personalized digital media content of a portable media playback device via a web browser from any physical location.

a. Network-based synchronization service

The content management process is performed by a user directly on the synchronization service website. The service keeps the record of registered user devices and user selection of media content for each device. The service also holds the actual media playback content.

b. Synchronization Port

The location where the device is physically connected to the system is called a “synchronization port.” The port is typically a user or public PC, internet kiosk, or the like. The connection port runs a synchronization controller process. This process recognizes the portable device and updates its media content.

c. Synchronization Process

Since device content metadata is centralized at the remote service database, it can be accessed from any machine from any location (port). The process of synchronization is initiated explicitly by the user or automatically based on a defined schedule. During the synchronization, the controller process reads the content list of the portable device and compares it with the desired content snapshot from the service (server). As a result of this comparison, the controller process creates a list of media that needs to be either added or removed. The controller then initiates content download from the service and copies downloaded media to the portable device. If the service contains media in a format that cannot be directly played on the portable device, the controller process will transcode such content into a supported format. In addition, the controller process handles mechanics of eventual content protection mechanism.

d. Network-Based Synchronization Optimization Methods

Synchronization sessions can move significant amounts of media content from the local machine (PC) to the remote playback device. In theory, the size of the session's content can be as big as the capacity of the remote playback device itself. Moving the entire content from the server could take a significant amount of time. Two cost reduction methods may be employed to reduce overall time needed to synchronize the device and/or to save bandwidth on the server side:
i. Sourcing Content from Local Media: Each media track that is scheduled for synchronization with the remote device will be first sourced from the local synchronization point (PC). If a desired media track cannot be found locally, an attempt will be made to fetch its content from the server (website). If the local media content is of a format that cannot be played directly on the device, such tracks will be transcoded while being synchronized. This method significantly saves overall bandwidth needed on the server side since most of user-owned content is actually stored on their local PC.
ii. Usage of High Efficiency Codec on the Server Side: The media content on the server that is used as a source of synchronization side is compressed with a high efficiency audio codec. A high efficiency codec is one that provides significant bandwidth reduction compared to regular audio codecs for the same psychoacoustic experience (e.g., High Efficiency AAC (HE-AAC)). Even though media encoded with such a codec cannot be played directly on most of today's remote playback devices, its compact format represents a great saving in bandwidth usage on the service side. In addition to the reduced bandwidth usage, the compactness of the high efficiency audio format significantly reduces storage requirements on the service side. During the remote synchronization process, high-efficiency encoded media is downloaded and then transcoded into a less efficient format of higher bitrate but one that is playable on a remote device (e.g., MP3 player). The higher bitrate of the final format is used in order to compensate for additional quality loss due to second encoding. Since the encoding occurs on the client side, it does not cause any additional requirement on the remote synchronization service side (website).

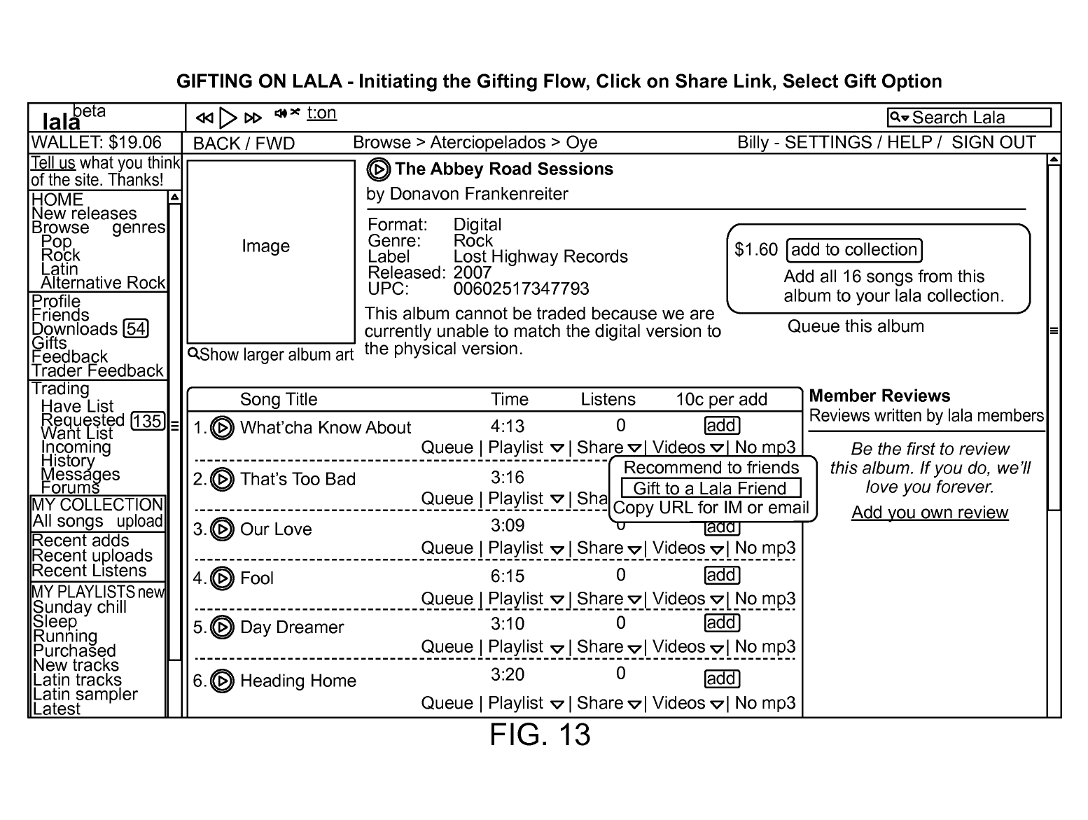

FIGS. 13-18 are screen shot displays of user interface screens associated with the gifting process described above. These figures show how a registered user (member) of the lala.com service can give a gift to another registered user (member). However, the scope of the gifting process includes the ability for non-members to give gifts to member.

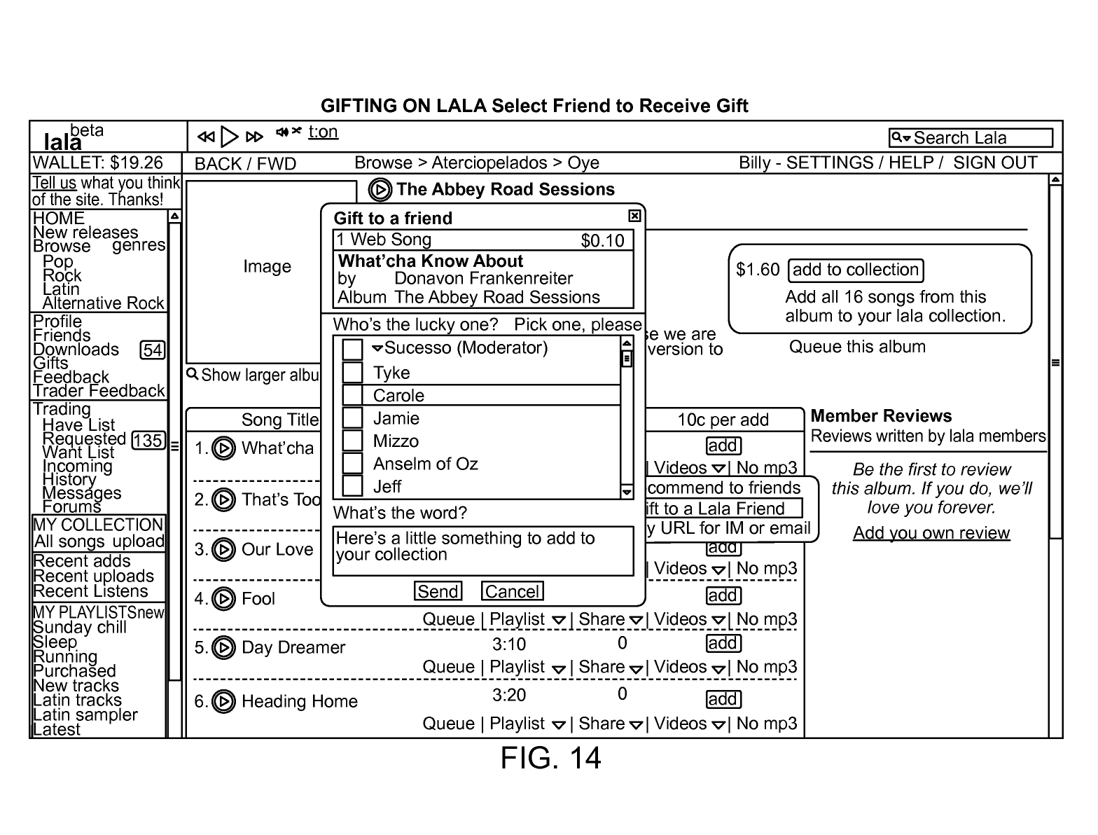

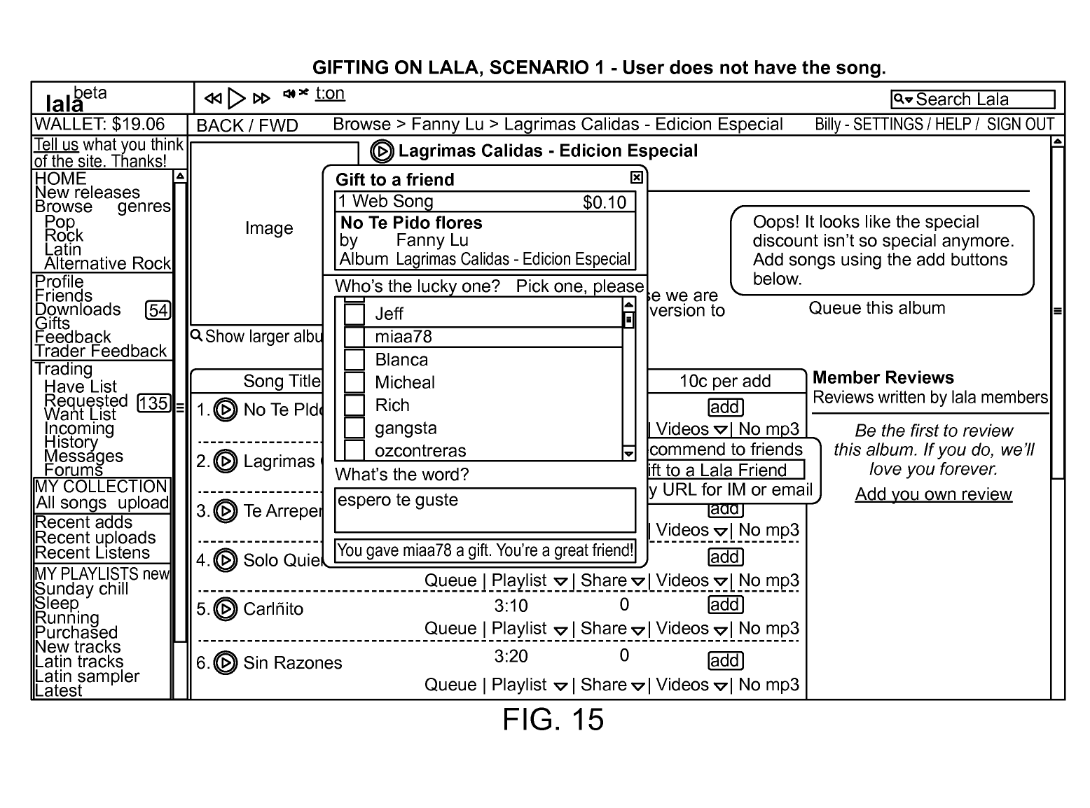

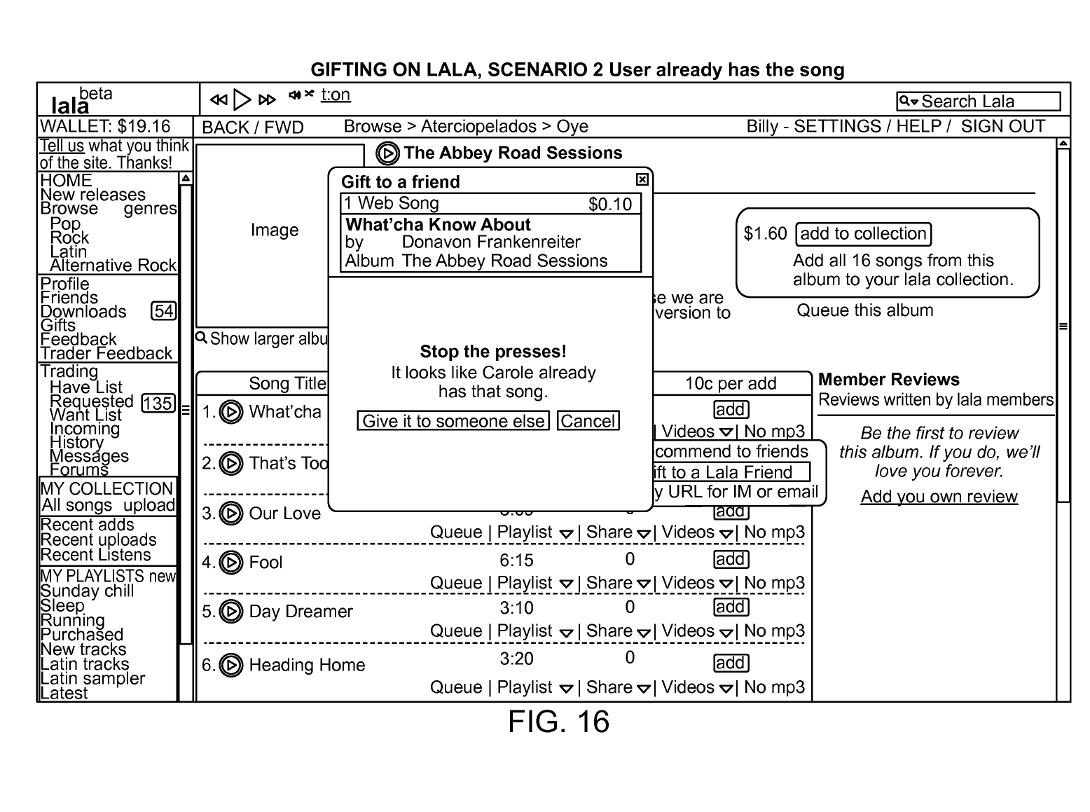

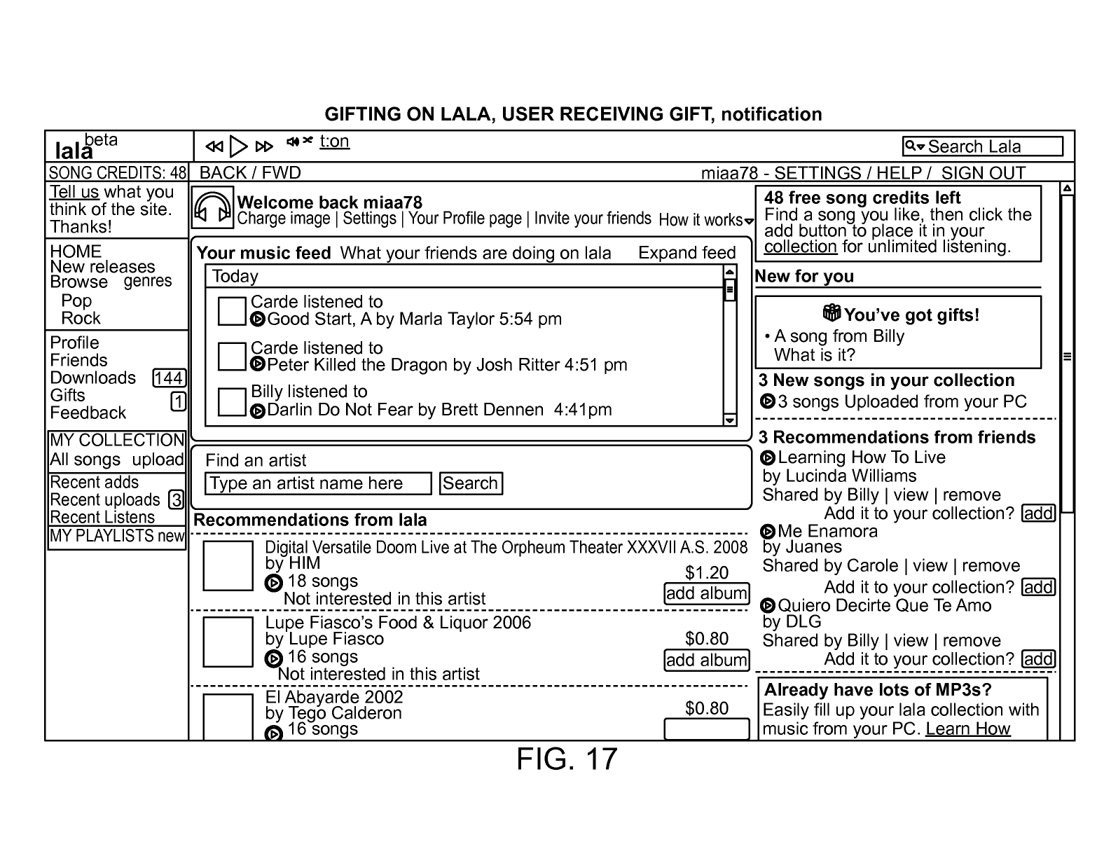

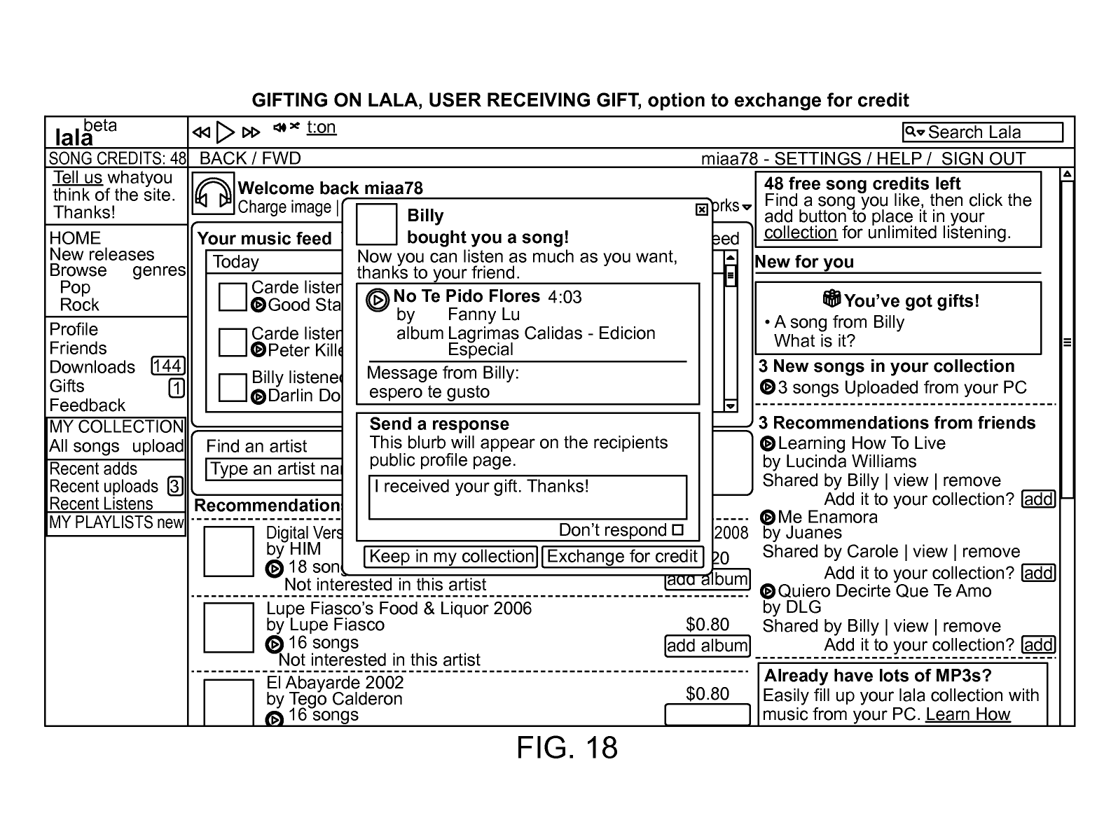

In FIG. 13, a member is reviewing songs of a specific album and selects a gift option (gift to a lala friend). In FIG. 14, the gifting member then selects the member to give the gift to and optionally enters a personal message. Here, the gift is a gift of one “Web Song.” FIG. 15 shows a transaction confirmation screen that appears if the gift recipient does not already own the Web Song. FIG. 16 shows a transaction aborted screen that appears if the gift recipient already owns the Web Song. The gifting member may then either select another gifting member or cancel the transaction. A third alternative selection option not shown in FIG. 16 is to request to see alternative gift(s) based on an analysis of the user's music collection, as discussed above. FIG. 17 shows a screen that the gift recipient sees the next time that they log in or refresh their session. FIG. 18 shows the screen that appears if the user clicks on the portion of the screen in FIG. 17 that announces the gift. The gift recipient is then provided with a variety of options, such as to send a response (user must click on “Keep in my collection”) or exchange the gift for credit (user must click on “Exchange for credit”). The gift recipient does not need to send a response or click on any of the options to have the song remain in their collection. That is, once the gift is made, the song is automatically placed in the user's digital list and is immediately available for accessing by the user. As discussed above, the user does not need to redeem credits, respond to an email message, or enter any codes, account numbers or passwords to receive the gift.

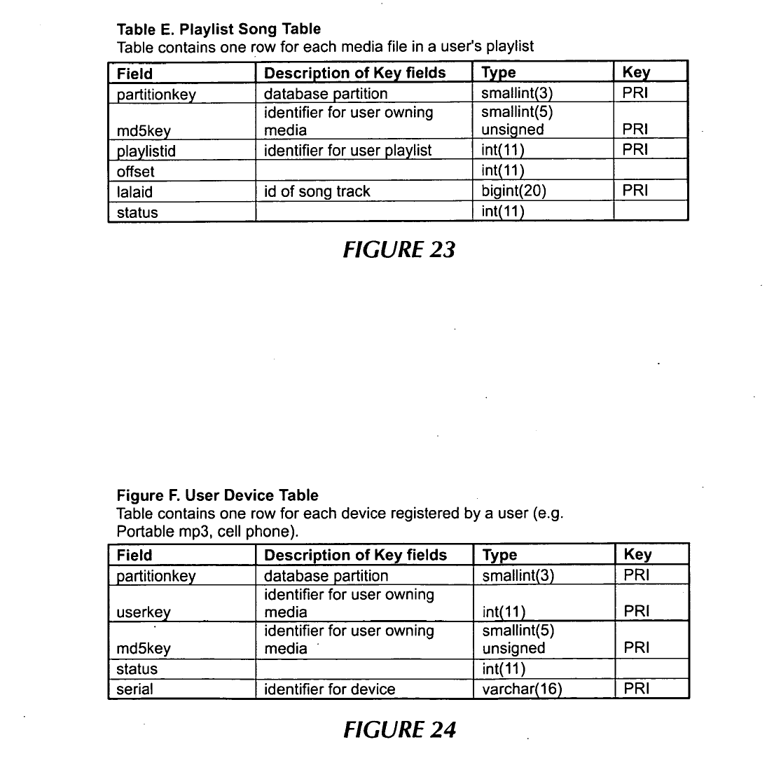

FIGS. 21-24 (Tables C-F, respectively) are additional self-explanatory tables used by the system 10 to administer the processes described herein.

Another embodiment for delivering digital media content files to media content devices allows for different levels of access rights depending upon the “type” of media content device that an individual digital media content file is delivered to. For example, a copyright owner of an individual digital media content file may permit unlimited streaming only to a particular type or class of a mobile phone or portable playing device, either for a set fee or even for no fee. In this manner, a manufacturer (e.g., Apple®) or service provider (e.g., cell phone carrier) could promote their products or services with marketing tie-ins to digital media content files but only with the strict access control provided by the service 10.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1-29. (canceled)

30. A computer-implemented method comprising:
hosting a plurality of digital media content files, each file being associated with at least one authorized user;
assigning a level of access rights to each of the digital media content files associated with each authorized user; and
maintaining records of:
(i) at least one of authorized user, and
(ii) level of access rights for each digital media content file associated with each authorized user; and
delivering individual digital media content files via an electronic network to a media content device associated with an authorized user in accordance with the authorized user's assigned level of access rights.

31. The method of claim 30, wherein the levels of access rights are selected from the group consisting of: no access, streaming a 30 second sample, time-limited streaming rights, number of plays limited streaming rights, shuffle only streaming rights, unlimited streaming rights, downloading of a portion of the digital media content file, downloading of the entire digital media content file.

32. The method of claim 30, further comprising:
providing a user interface that enables a user to change the level of access rights currently assigned to at least one digital media content file.

33. The method of claim 32, wherein a user may change the level of access rights currently assigned to a digital media content file by submitting a payment.

34. The method of claim 32, wherein a user may change the level of access rights currently assigned to a digital media content file associated with a different user.

35. The method of claim 30, wherein the levels of access rights associated with the owner of the copyright.

36. The method of claim 30, wherein the host computer system includes a plurality of sources of digital media content files.

37. The method of claim 30, wherein the digital media content files are digital music files and the media content devices are digital music players.

38. A system comprising:
a processor;
a module configured to control the processor to host a plurality of digital media content files, each file being associated with at least one authorized user;
a module configured to control the processor to assign a level of access rights to each of the digital media content files associated with an authorized user; and
a module configured to control the processor to maintain records of:
(i) at least one authorized user, and
(ii) level of access rights for each digital media content file associated with each authorized user; and
a module configured to control the processor to deliver individual digital media content files via an electronic network to a media content device associated with an authorized user in accordance with the authorized user's assigned level of access rights.

39. The system of claim 38, wherein the levels of access rights are selected from the group consisting of: no access, streaming a 30 second sample, time-limited streaming rights, number of plays limited streaming rights, shuffle only streaming rights, unlimited streaming rights, downloading of a portion of the digital media content file, downloading of the entire digital media content file.

40. The system of claim 38, further comprising:
a module configured to control the processor to provide a user interface that enables a user to change the level of access rights currently assigned to at least one digital media content file.

41. The system of claim 40, wherein a user may change the level of access rights currently assigned to a digital media content file by submitting a payment.

42. The system of claim 40, wherein a user may change the level of access rights currently assigned to a digital media content file associated with a different user.

43. The system of claim 38, wherein the levels of access rights associated with the owner of the copyright.

44. The system of claim 38, wherein the host computer system includes a plurality of sources of digital media content files.

45. The system of claim 38, wherein the digital media content files are digital music files and the media content devices are digital music players.

46. A non-transitory computer-readable storage medium storing instructions which, when executed by a computing device, cause the computing device to maintain a plurality of digital media content files and records of authorized users, the instructions comprising:
hosting a plurality of digital media content files, each file being associated with at least one authorized user;
assigning a level of access rights to each of the digital media content files associated with each authorized user; and
maintaining records of:
(i) at least one of authorized user, and
(ii) level of access rights for each digital media content file associated with each authorized user; and
delivering individual digital media content files via an electronic network to a media content device associated with an authorized user in accordance with the authorized user's assigned level of access rights.

47. The non-transitory computer-readable storage medium of claim 46, wherein the levels of access rights are selected from the group consisting of: no access, streaming a 30 second sample, time-limited streaming rights, number of plays limited streaming rights, shuffle only streaming rights, unlimited streaming rights, downloading of a portion of the digital media content file, downloading of the entire digital media content file.

48. The non-transitory computer-readable storage medium of claim 46, the instructions further comprising:
providing a user interface that enables a user to change the level of access rights currently assigned to at least one digital media content file.

49. The non-transitory computer-readable storage medium of claim 48, wherein a user may change the level of access rights currently assigned to a digital media content file by submitting a payment.

50. The non-transitory computer-readable storage medium of claim 48, wherein a user may change the level of access rights currently assigned to a digital media content file associated with a different user.

51. The non-transitory computer-readable storage medium of claim 46, wherein the levels of access rights associated with the owner of the copyright.

52. The non-transitory computer-readable storage medium of claim 46, wherein the host computer system includes a plurality of sources of digital media content files.

53. The non-transitory computer-readable storage medium of claim 46, wherein the digital media content files are digital music files and the media content devices are digital music players.
